(19) United States
(12) Patent Application Publication
(10) Pub. No.: US 2003/0104842 A1
(43) Pub. Date: Jun. 5, 2003

(54) Hands-free speakerphone device for mobile terminals

(75) Inventors: Young Choi, Daegukwangyeok-shi (KR); Jae-Goo Choi, Kyungsangbuk-do (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/998,085

(22) Filed: Nov. 30, 2001

(51) Int. Cl. H04M 1/00

(52) U.S. Cl. 455/569; 455/550; 455/575

(57) ABSTRACT

A portable speakerphone device comprising a microphone and broadcast speaker external to the mobile terminal, preferably supported on a lanyard-type device, for providing optimal spatial positioning to eliminate howling and to provide other means of shielding unwanted ambient interference to optimize acoustic performance.

### BACKGROUND OF THE INVENTION

1. Field of the Invention

The present invention relates generally to mobile speakerphone communication devices, and in particular to a mobile speakerphone device that is supported by the user of the device.

2. Description of the Related Art

Mobile terminals fall into two broad categories which include all forms of wireless personal communication services, and are generally referred to as cordless telephones and cellular telephones. Cordless phones, also referred to as mobile phones, mobile terminals and the like, connect the user to the Public Switched Telephone Network (PSTN) via a quickly installed two way radio communication system that is inexpensive and light weight, and typically utilize low powered handsets that communicate with a base station at 900 MHz and are limited to a range of less than 50 meters. In contrast, cellular users connect to the PSTN via any one of a plurality of base stations that are installed and maintained by a third party service provider. Cellular phone users can roam over a wide geographic region, with the system's ability to handoff between base stations maintaining a continuous PSTN connection.

Myriad attempts have been made and devices exist to enhance a user's hearing and to improve the manner in which audio signals are received. For example, Lehr et al., U.S. Pat. No. 5,793,875, describes a device configured about and supported by a lanyard-type necklace for improved hearing and acoustic enhancement.

Sanserino, U.S. Pat. No. 5,748,707, describes an improved speakerphone system. Conventional speakerphones depend chiefly on a base mounted speaker of significant size having power requirements beyond the range available from mobile terminals. The system of Sanserino, allows the user some flexibility to roam, but its base station is not mobile, and is hard wired to the PSTN system. The housing of the base contains an FM receiver and antenna to receive signals from a microphone/transmitter device worn by the user. The user's freedom to roam is limited to the user's hearing range from the base station loudspeaker. Moreover, should the user chose to walk about, such movement will cause the acoustic path of the desired signal to vary, creating unwanted interference, changes in reflected and reverberated sound, which will lead to the echo and barrel sounds common in speakerphone systems. Importantly, these random variations frequently create excess feedback and a howling sound.

Although the system of Sanserino will maintain an essentially fixed distance between the user and microphone, it does not overcome the feedback interference caused by spatial variation between the microphone and the speaker. The shortcomings of Sanserino are further evident in the systems of Toda, U.S. Pat. No. 5,526,405, Kim, U.S. Pat. No. 6,055,309, and Dent et al., U.S. Pat. No. 5,680,450, which utilize electronic filtering and delaying circuits to cancel speakerphone echo.

Hands-free kits are widely available for mobile terminals. These kits provide small speakers that are worn in or immediately adjacent to the user's ear, which are commonly referred to as ear buds. The speakers provided in these hands-free kits are small in size, have minimal power demands, and lack broadcast functionality.

Therefore, a need exists for a portable hands-free device to provide the user with superior speaker phone performance and that is configured so that it can be supported by the user.

### SUMMARY OF THE INVENTION

It is, therefore, an object of the present invention to provide a fully mobile hands-free device that provides speakerphone functionality in mobile terminals.

It is another object of the present invention to reduce the weight of the speakerphone apparatus and to reduce the power demands that the speakerphone apparatus imposes upon a mobile terminal.

It is yet another object of the present invention to provide the user of the speakerphone apparatus with a more comfortable and more functional device that is fully transportable and that can be fully supported by the user.

Another object of the present invention is to provide a system that can transport the entire speakerphone in a hands-free manner without sacrificing the mechanical conditions necessary for high audio quality, such as speaker size and microphone and speaker gain.

It is yet another object of the present invention to provide a relatively fixed spatial separation between speaker and microphone, thereby reducing the howling effect, and allowing operation in areas of high ambient noise without significant degradation of performance.

The above and other objects are achieved by providing and incorporating the loud speaker type and microphone in a device worn by the user. The device includes a mobile terminal, a hands free speakerphone device for amplifying the audio signal received by the mobile terminal, a switch for transferring between the speaker of the mobile terminal and the external speaker of the speakerphone, an output port for electrically connecting the hands-free device to the mobile terminal, for electrically connecting an external speaker to the amplifier, and for electrically connecting an external microphone to the output port; with a means to attach the external speaker and external microphone to the mobile terminal user.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram showing the internal structure of a mobile terminal known in the prior art;

FIG. 2 is a block diagram of a mobile terminal that operates in accordance with the system of the present invention;

FIG. 3a is a plan view of the hands-free device of the present invention supported on a lanyard;

FIG. 3b is a plan view of the hands-free device of FIG. 3a including the lanyard and additional accessories in accordance with the present invention;

FIG. 3c illustrates another embodiment of the present invention including a partial lanyard arrangement to support the device on a user's person;

FIG. 3d illustrates a user wearing the device of the present invention;

FIG. 4 is a schematic circuit diagram of the present invention illustrating a mode select switch and a speaker select switch;

FIG. 5 is a schematic view of the hands-free device of the present invention illustrating an external battery and amplifier; and

FIG. 6 is a schematic circuit diagram of an additional embodiment of the present invention.

### DETAILED DESCRIPTION OF THE PREFERRED EMBODIMENTS

The following detailed description of preferred embodiments of the invention is made in reference to the accompanying drawings. In the description below, explanation about related functions or constructions, which are known in the art, will be omitted for the sake of clearness in understanding the concept of the invention.

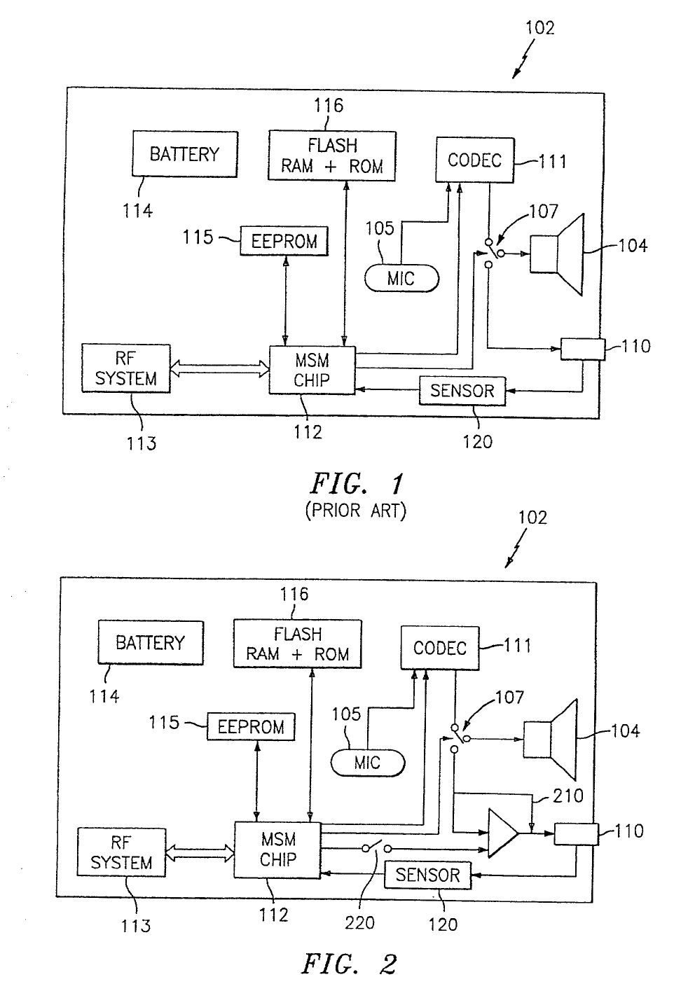

FIG. 1 is a block diagram representing a system of the mobile terminal 102 known in the prior art. Within the mobile terminal 102 typically exists a battery power source 114, a Radio Frequency (RF) system interface 113, an Mobile Station Modem™ (MSM) chip 112 and ancillary control devices, electronically erasable programmable read only memory (EEPROM) 115, as well as flash Random Access Memory (RAM) and flash Read Only Memory (ROM) 116, which are controlled by MSM chip 112 and serve the memory means of the control circuitry. Also commonly found in a mobile terminal 102 of the prior art is a microphone (MIC) 105 for converting an audio signal into an equivalent electrical signal, which is sent to the codec chip 111, the function and operation of which are recognized and well known in the art as typically controlled and programmed by a microcontroller such as MSM 112. MSM 112 typically provides an integrator, audio-codec, Phase Locked Loop (PLL), Digital to Analog Converter (DAC), and Analog to Digital Converter (ADC) as on-chip components, and will optimally provide a system of acoustic echo cancellation to supplement the advantageous echo-canceling fixed spatial positioning arrangement of the present invention.

It is recognized that the mobile terminal that may be used with the apparatus and method of the invention includes all forms of wireless telephony, including PCS, cordless and cellular phones. One of ordinary skill in the art will recognize that the RF system interface 113 can be of varied type, dependent upon the type of mobile terminal, and will typically encompass cellular systems having varied modulation techniques within their RF section.

The codec 111 typically also controls the speaker 104, which is driven by an internal amplifier (not shown). Speaker 104, as with the other components in FIG. 1, is contained within the mobile terminal 102. A low power speaker or ear phone that fits within the user's ear (commonly referred to as an ear bud 106) is an external accessory to the mobile terminal 102 that connects to codec 111 through output port 110. As shown in FIG. 1, a sensor 120 monitors whether earbud 106 connection is made to output port 110. If such connection is detected, the sensor will provide such indication to the MSM chip 112 which will operate a speaker switch 107, which though shown as a separate component in FIG. 1 is preferably internal to the codec 111, and provides a switching means by which to alternate between speaker 104 and earbud 106, via output port 110. It will be recognized that the MSM chip 112, codec 111 and switch 107 can readily be programmed and arranged to allow either the alternate functioning of speaker 104 or earbud 106, which is the preferred arrangement, or when conditions such as a plurality of users or varying ambient noise level dictate simultaneous operation of speaker 104 and earbud 106.

FIG. 2 is a block diagram showing additional features that can be placed internal to mobile terminal 102 to drive the preferred embodiment of the invention. Amplifier 210 boosts the output signal and is preferably activated via a mode control switch 220 that functions as an on/off control of amplifier 210 when the sensor 120 recognizes that a wearable speaker 330 is connected to or is to be operated from mobile terminal 102.

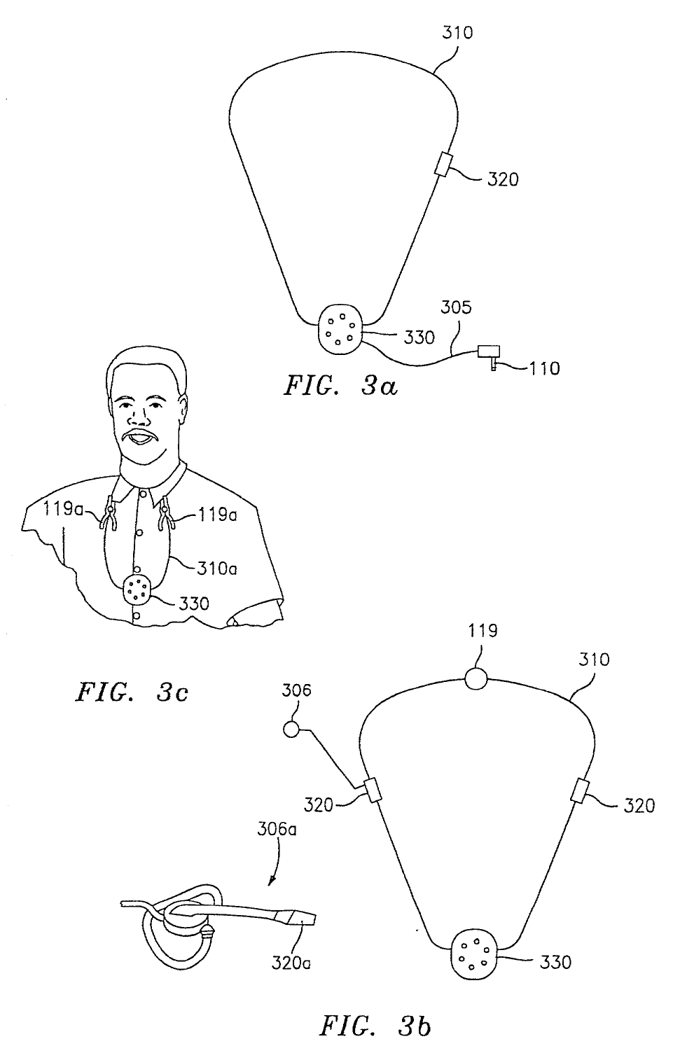

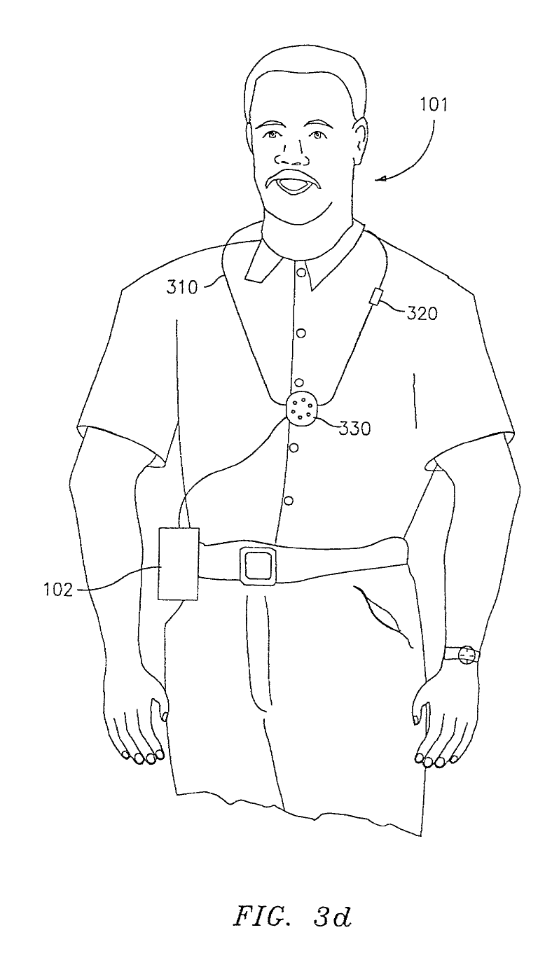

Referring now to FIG. 3, wireless speaker 330 is depicted in FIG. 3a as being slideably affixed to a lanyard 310. Alternatively and preferably in conjunction with connection to the lanyard 310, wearable speaker 330 can be attached to the clothing of a user 101 by means of a clasping device 315 (not shown). Clasping device 315 can comprise a pin, a clasp, or other clip-on device, as well as a friction type affixing device, such as Velcro™, as are well known in the art to allow the user to affix the wearable speaker 330 to his or her person, clothing or accessory, preferably while allowing lanyard 310 to continue to support some of the weight of wearable speaker 330.

The relative sizes of wearable MIC 320 and wearable speaker 330 may cause a weight disparity between the MIC 320 and speaker 330. This weight disparity will cause the wearable speaker 330 to position itself nearly at the bottommost position on lanyard 310. It is preferred that the wearable speaker not be permanently affixed to lanyard 310, but in addition to clasping device 315, will have a means to allow the user 101 to selectively affix wearable speaker 330 to a particular position on lanyard 310.

To allow for optimal performance, wearable MIC 320, as depicted in FIG. 3a, is positioned approximately six inches from the mouth of user 101, a distance which is dictated by the characteristics of the particular MIC 320 and that can widely vary in accordance with the present invention. Wearable MIC 320 is preferably a clip-on type microphone, which is lightweight and inexpensive to manufacture. The preferred embodiment will use an omni-directional microphone similar to the type used in hands-free mobile terminal kits, which typically have a frequency response of 16 to 20 kHz, impedance of 600 Ohms and sensitivity of 60 dB ±3 dB. Of course, the device of the present invention will operate with other and typically more expensive microphones, as well as with microphones having other technical characteristics, though a preferred embodiment may include a variable adapter to allow the system to interface with all available types of mobile terminals.

Also shown in FIG. 3a is a type of electrical connection 305 between the lanyard-supported acoustical components, i.e., wearable MIC 320 and wearable speaker 330, and mobile terminal 102. FIG. 3a portrays a most basic and low cost type of connection, of a jack that simply plugs into output port 110. It will be recognized that the electrical connection 305 can alternatively be accomplished using other means including Bluetooth™ wireless technology, allowing user 101 to eliminate the short run of wire between the external components of the system and the mobile terminal.

The preferred embodiment employs a dynamic type wearable speaker 330. Dynamic speakers, also referred to as electrodynamic type, are a common type of loudspeaker transducer commonly employed in home sound reproduction systems, and have an advantage of low price, and are preferred over other types of speakers such as magnetic planar array and ribbon speakers. Dynamic speakers typically comprise a driver, a diaphragm, a coil, a spider, a stationary magnet, a suspension, and a basket that is structurally arranged to convert an applied electrical signal into an audible acoustic wave.

FIG. 3b is another embodiment of the invention, with a clasp 119 provided to facilitate the user 101 putting on and taking off the lanyard. FIG. 3b illustrates the additional components of ear bud 306 and mode select switch 340, which can be contained in a common housing that is separate from the housing of wearable MIC 320, as depicted in FIG. 3b, or can share the housing with either wearable MIC 320, with wearable speaker 330, or with both or with other components. Preferably the components will be positioned on opposite sides of the lanyard for weight distribution and balance purposes. An alternative embodiment locates wearable MIC 320 in the same housing as wearable speaker 330, and preferably utilizes electronic echo cancellation systems, such as those described in Dent et al., U.S. Pat. No. 5,680,450, to reduce howling and retransmission of the signal broadcast by wearable speaker 330. Dent et al. is incorporated by reference.

Further, wearable MIC 320 need not be affixed to or supported by lanyard 310 or partial lanyard 310a, and may be supported from the ear of the user 101, as is common with hands-free kits that incorporate the MIC and ear bud in a single assembly 306a, as shown in FIG. 3b, or clipped directly onto the user 101 or the clothing of user 101.

Another embodiment utilizes a partial lanyard 310a, having modified lanyard clasps 119a is shown in FIG. 3c, wherein each modified lanyard clasp 119a can be affixed to a preferred position on the user 101 or on an article of clothing or accessory worn by user 101.

FIG. 3d is a schematic showing an embodiment of the present invention being worn by user 101 with wearable speaker 330 and wearable MIC 320 optimally positioned and supported by lanyard 310. Mobile terminal 102 is supported on the belt of user 101 using a standard mounting holder and the electrical connection 305 is accomplished via wireless short-range technology, such as by Bluetooth™ protocol.

Another embodiment comprises a plurality of external speakers that are supported by the lanyard and are positioned at equidistant positions from the bottommost portion of the lanyard, allowing user 101 to comfortably carry more than a single wearable speaker 410 and providing increased amplification by the hands-free device of the signal received from the mobile terminal.

It will be recognized that mobile terminal 102 can be worn on lanyard 310, a particularly attractive alternative for women or persons not wearing belts and an alternative that will become more popular as mobile terminals continue to become smaller. A clasping device 315 will allow the wearable speaker 330 to remain in an optimal position in the event that the lanyard 310 is used to carry a comparatively heavy mobile terminal 102.

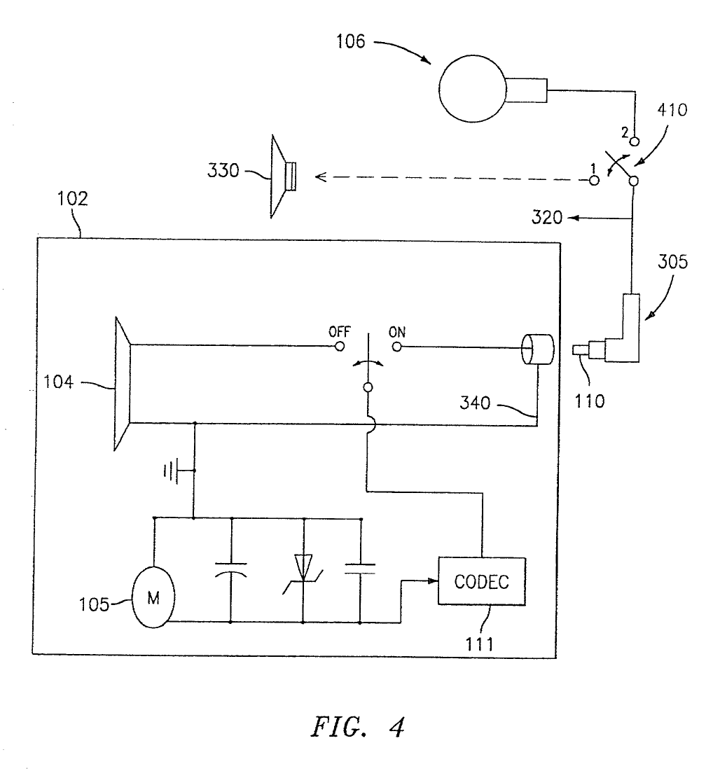

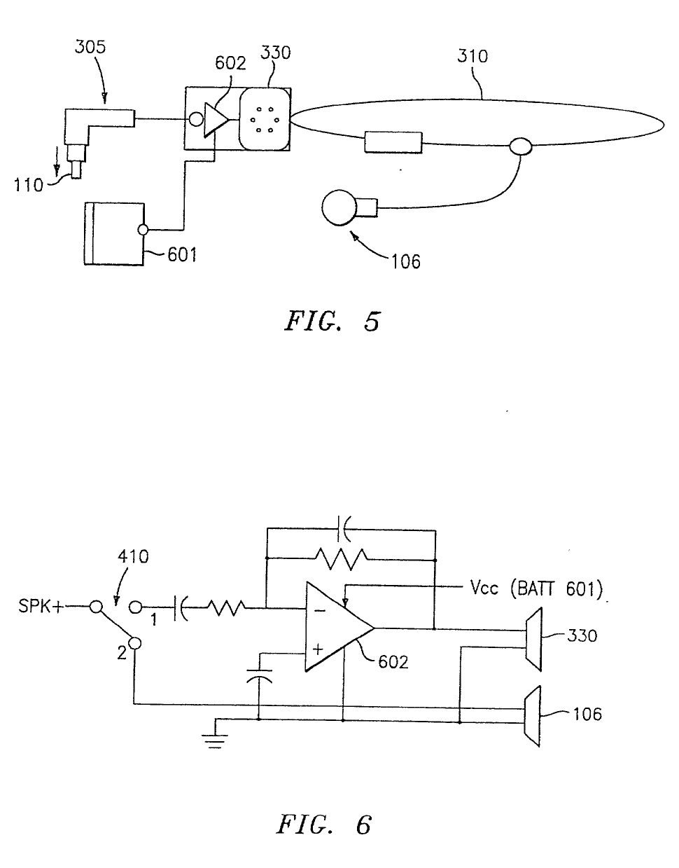

Yet another embodiment of the present invention allows the lanyard 310 to be dispensed with, and the components of the invention are supported by user 101 or the user's clothing or accessory (e.g. knapsack, hat, etc.) worn by user 101. For example, wearable MIC 320 can be supported from various parts of the user's anatomy, such as the ear, hair or pierced body part, or may be attached to the user's tie, shirt, blouse or collar. Wearable speaker 330 can be similarly attached or supported, such as by the user's belt. Referring to FIGS. 4-5, mode select switch 340, external battery 610, and external amplifier 602 (if so equipped) can be located in a common housing or in separate housings that is/are similarly supported in a position allowing convenient access and electrical connection 305.

An embodiment of the structure of circuit of mode select switch 340 is provided in FIG. 4. When sensor 120 detects a connection to output port 110, a “HIGH” output port sense signal is sent to MSM 112, requesting disconnect of speaker 104, which is internal to mobile terminal 102, and switching to an external speaker as described in Table 1.

TABLE 1

| External | Output | Mode | Amplifier | Speaker |
|---|---|---|---|---|
| Device | port | Select | Status | Select Switch |
| Connected | Sense | Switch (340) | (FIG. 5) | (410) Position |
| None | LOW | OFF | OFF | Maintain state |
| | | | (BYPASS) | |
| Speaker (330) | HIGH | ON | ON (GAIN) | 1 |
| Ear Bud (106) | HIGH | ON | OFF | 2 |
| | | | (BYPASS) | |

As depicted in Table 1 and in the embodiment in FIGS. 4 and 6, and distinguished from the automatic operation of speaker switch 107, mode select switch 340 allows user 101 to select, without physically disconnecting electrical connection 305, whether to utilize speaker 104 or to broadcast sound from an external speaker, either speaker 330 or earbud 106, depending upon the position of speaker select switch 410. Control for the mode select switch 340 is preferably located in the same housing as the control or the speaker select switch 410. Moreover, it is preferable that the position of mode select switch 340 be maintained regardless of a change in power condition (i.e. standby or power off condition) of mobile terminal 102, preferably excluding a sensed disconnect of electrical connection 305, either by sensor 120 or equivalent powering down of a Bluetooth™ module, if provided.

Although not required for operation of the invention, the mode select switch 340 is shown in FIG. 4 as connecting the ground of earbud 106, wearable speaker 330 and wearable MIC 320. It will be recognized that these devices need not share a common ground connection, and, similarly, the separate connections shown as MIC line and speaker line may be combined.

It is important that the speaker switch 410 alert MSM 112 to enable an audio amplifier when wearable speaker 330 is selected. Such alert need not be made when an alternate embodiment of the invention is implemented, as shown in FIG. 5 in which power to wearable speaker 330 is supplemented by a battery 601 providing energy V_{cc} to an amplifier 602 external to mobile terminal 102. It is preferred that this amplifier 602 be located external to mobile terminal 102, and may be conveniently placed in the housing shared by mode select switch 340 and speaker select switch 410, or elsewhere on lanyard 310.

It will be recognized that this embodiment that includes external battery 601 can be universally implemented via the extant hands-free device connection output port of commercially available mobile terminals. Absent providing an additional jack or socket to allow external battery 601 to supply power to the mobile terminal 102 itself (effectively acting as a second internal battery 114), the loudness and range of the wearable speaker 330 are constrained by range of amplifier 210 that is internal to mobile terminal 102 and the power available from internal battery 114. In addition to providing a more desirable output from wearable speaker 330 and an increased life of internal battery 114, the embodiment of FIGS. 5 and 6 can be configured to be universally compatible with the varied types of mobile terminals 102. Moreover, this embodiment allows for use of a wearable speaker 330 having acoustical parameters and impedance that are not otherwise compatible with mobile terminals 102.

As shown in FIG. 5, one reason that external battery 601 is used for supplying power to an external amplifier 602 is that the standard ear-phone jack used in the mobile terminal 102 is a two-port ear-phone jack which does not provide power externally. Herein, if the mobile terminal may use a four port ear-phone jack (or a four contact ear-phone jack), the power can be externally output via port 110 and thereby, the external battery 601 may not be separately required.

In addition, the dynamic type wearable speaker 330 of the invention is typically of low cost, as are the other components of the invention, making the entire arrangement less expensive than most available hands-free kits. Moreover, the system of the invention can be fitted with impedance matching and other necessary switches to provide compatibility with all commercial mobile terminals.

Particular benefits of the embodiments of the present invention are that the user 101 can utilize the speakerphone system in a hands-free mode with the speakerphone system being fully portable, having no wires connecting the user 101 to the PSTN and maintaining an essentially fixed spatial separation is maintained between wearable speaker 330 and wearable MIC 320. The device is positioned to negate a majority of the reverberated sound, limit variations in the path of the preferred acoustic signal, and allow the body of user 101 to shield the system from unwanted directional or ambient noise.

Maintaining a fixed spatial separation is a primary factor in ensuring a uniform acoustical path for the transmitted sound and factors into the reduction of the unwanted howling effect and barrel sound of speakerphone systems. The previously known speakerphone systems attempt to eliminate howling and barrel sound by use of heavy and expensive microphone and speaker components or by electronic signal cancellation. Moreover, because the arrangement of the present invention operates to eliminate the cause of the unwanted howling and barrel sound, it does not suffer from the inherent time delay that accompanies electronic cancellation systems.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A hands-free device for use with a mobile terminal, the mobile terminal including an amplifier for amplifying an audio signal that is received by the mobile terminal, a switch for selecting between a speaker of the mobile terminal and an external speaker, and an output port for electrically connecting the hands-free device to the mobile terminal, the hands-free device comprising:
the external speaker electrically connected to the amplifier through the output port;
an external microphone electrically connected to the output port; and
means for attaching the external speaker and the external microphone to a mobile terminal user.

2. The hands-free device claimed in claim 1, wherein the external speaker and the external microphone are fixedly attached to the user at positions providing a constant spatial separation.

3. The hands-free device claimed in claim 1, further comprising an ear bud.

4. The hands-free device claimed in claim 1, wherein the external speaker is driven by an external amplifier that is powered by an external battery.

5. The hands-free device claimed in claim 4, wherein the external speaker and the external battery share a common housing.

6. The hands-free device claimed in claim 1, wherein the external speaker and the external microphone share a common housing.

7. The hands-free device claimed in claim 1, further comprising a mode select switch to switch between the external speaker or an internal speaker.

8. The hands-free device claimed in claim 7, wherein the mode select switch, the external speaker and the external microphone share a common housing.

9. The hands-free device claimed in claim 7, wherein the mode select switch and the external microphone share a common housing.

10. The hands-free device claimed in claim 1, wherein the external speaker is slideably affixed to and substantially supported by a lanyard.

11. The hands-free device claimed in claim 10, wherein the external speaker is positioned at a bottommost position on the lanyard.

12. The hands-free device claimed in claim 10, wherein the external speaker is driven by an external amplifier that is powered by an external battery, wherein the external battery is supported by the lanyard.

13. The hands-free device claimed in claim 10, wherein the external speaker, the external microphone, and the external battery share a common housing.

14. The hands-free device claimed in claim 1, wherein the external speaker comprises a plurality of speakers that are supported by a lanyard and positioned at equidistant positions on the lanyard.

15. A hands-free device for use with a mobile terminal, the mobile terminal including an output port for electrically connecting the hands-free device to the mobile terminal and an amplifier for powering a speaker, the hands-free device comprising:
an external amplifier electrically connected to the output port for amplifying an audio signal received from the mobile terminal;
a wearable speaker electrically connected to the external amplifier;
an external microphone electrically connected to the output port; and
means for attaching the wearable speaker and the microphone to the hands-free device user.

16. The hands-free device claimed in claim 15, wherein a spatial separation between the wearable speaker and the external microphone is fixed.

17. The hands-free device claimed in claim 15, further comprising an ear bud.

18. The hands-free device claimed in claim 15, wherein the external amplifier is powered by an external battery.

19. The hands-free device claimed in claim 18, wherein the wearable speaker and the external battery share a common housing.

20. The hands-free device claimed in claim 15, further comprising a mode select switch to switch between the external speaker or an internal speaker.

21. The hands-free device claimed in claim 20, wherein the mode select switch and the external microphone share a common housing.
